(19) United States
(12) Patent Application Publication
(10) Pub. No.: US 2019/0198862 A1
(43) Pub. Date: Jun. 27, 2019

(54) High Performance Carbonized Plastics for Energy Storage

(71) Applicant: Ionobell, San Jose, CA (US)

(72) Inventors: Brennan J. Campbell, San Jose, CA (US); Robert C. Ionescu, Sunnyvale, CA (US)

(21) Appl. No.: 16/222,074

(22) Filed: Dec. 17, 2018

Related U.S. Application Data
(60) Provisional application No. 62/697,680, filed on Jul. 13, 2018.
(60) Provisional application No. 62/608,932, filed on Dec. 21, 2017.

(51) Int. Cl. H01M 4/1393; C01B 32/05; H01M 4/587; H01M 4/04; H01G 11/34; H01G 11/36; H01G 11/52; H01G 11/62; H01G 11/46; H01G 11/86; H01G 11/78; H01G 11/44; H01G 11/50; D01D 5/00; D01F 9/20

(52) U.S. Cl. CPC H01M 4/1393; H01M 2004/027; H01M 4/587; H01M 4/0485; H01G 11/34; H01G 11/36; H01G 11/52; H01G 11/62; H01G 11/46; H01G 11/86; H01G 11/78; H01G 11/44; H01G 11/50; D01D 5/003; D01F 9/20; C01P 2006/40; C01P 2004/03; C01P 2002/82; C01P 2002/85; C01P 2002/72; C01B 32/05

(57) ABSTRACT

Pyrolysis (carbonization) of various plastics, including recycled plastic, can generate carbonaceous materials cheaply and in bulk, which can then be converted into energy storage device materials, e.g., carbon anode active material for Li-ion batteries. The plastic can be dissolved in a suitable solvent or acid, or can be melted. Once liquefied it can be loaded into vessels for extrusion via an electrospinner. Polymer fibers may be formed from the liquefied plastic on the nano- and micro scales, and collected on a substrate, forming a fabric. These fibers can be converted to high purity carbon and used as electrode materials in batteries and supercapacitors. The fibers can also be coated with Ppy prior to pyrolysis; this helps fibers retain their morphology during carbonization. The fibers can also be loaded with additive particles to enhance their electrochemical performance or alter the composite properties.

### RELATED APPLICATIONS

This application claims the benefit of priority to U.S. Provisional Patent Application Ser. No. 62/608,932 filed Dec. 21, 2017 and U.S. Provisional Patent Application Ser. No. 62/697,680 filed Jul. 13, 2018. Both applications are hereby incorporated by reference in their entireties.

### BACKGROUND

Graphite is currently the incumbent active material for lithium-ion battery negative electrodes, which has a theoretical specific capacity of 375 mAh/g.

Batteries are highly expensive (30% of the cost comes from the electrode materials), and still suffer from relatively low specific and volumetric energy density. These are also limitations of incumbent active materials. Batteries need to store more energy per weight and volume in order to increase the miles per charge, for example, in electric vehicles. Lithium-ion battery anodes are typically produced using materials and processes that are harmful to the environment, such as toxic polymer precursors and organic solvents.

### SUMMARY

Plastics are an ever-increasing source of waste, and partially as a result as an ever-increasing rate of production; especially plastic bottles. Just between the years 2010-2015, worldwide plastic production increased to 322 million tons; an increase of ˜25% in only 5 years. See https://committee.iso.org. To help reduce the amount of plastic waste that accumulates in the environment, new uses for these plastics are needed, especially in functional materials and devices.

As disclosed herein, plastics may be converted to high purity carbon materials after thermal pyrolysis (carbonization) and can be utilized at high performance active material for energy storage devices, e.g., Li-ion batteries. Suitable thermoplastics and other types of plastics include those found in water bottles (polyethylene terephthalate (PET)), as well as polyamides, polycarbonates, polyesters, polyethylenes, polypropylenes, polystyrenes, polyurethanes, polyvinyl chlorides, polyvinylidene chlorides, acrylonitrile butadiene styrenes, polyepoxide trifluorides, polymethyl methacrylates, polytetrafluoroethylenes, phenolics, melamine formaldehydes, urea-formaldehydes, polyetheretherketones, maleimides, polyetherimides, polyimides, plastarches, polylactic acids, furans, silicones, and/or combinations thereof, and other non-consumer and post-consumer plastics. Such plastics may be carbonized under the right conditions to form a high purity carbon material product for implementation of energy storage devices such as Li-ion batteries, etc., as an active material. Accordingly, plastic-derived carbon can be produced to provide improved graphite and activated carbons for use as active materials in lithium-ion batteries and supercapacitors with higher performance in terms of specific capacity, energy density, power density, and capacitance. Herein, the terms pyrolysis and carbonization are used interchangeably.

In particular, embodiments of the invention provide alternative advanced energy storage materials, using plastic-derived carbon precursors that can be an alternative to the conventionally used active material in Li-ion battery anodes, graphite. Graphite has a theoretical specific capacity of 375 mAh/g, and can be formed by using carbonizing plastic, such as plastic bottles, plastic bags, or any other type of plastic.

The materials used to form the final active material used in energy storage devices may be collected from waste sources, recycling centers, or even pre-consumer sources. Plastic bottles are a predominant source of waste plastic and work excellently as a carbon precursor for this Li-ion anode application.

Plastics may be found anywhere along the production/consumer/waste streams in society, and as the majority of them are thermoplastics, they tend to undergo thermal decomposition in a way that is different from other organic materials. For example, under inert atmosphere (Ar, etc.) and at temperatures between 100-300° C. (depending on the melting point), most thermoplastics tend to begin to decompose and/or gasify. At temperatures at or above 300-450° C., they even start to boil and further volatilize/gasify. It is around this phase transformation that thermal pyrolysis also occurs in parallel (450-1200° C.); the carbonaceous products become evident and manifest as various morphologies and appearances after this stage (up to 1200° C.). To achieve the highest possible degree of graphitization in this material, the temperature may be ramped up to as high as 3500° C. The resulting black carbon material may be collected and prepared further for use in a Li-ion electrode through blending into a slurry, or another electrode fabrication method. This material prepared in accordance with embodiments of the invention may be low cost with a low carbon footprint, and may be advantageous over natural and synthetic graphites due to a higher theoretical capacity and enhanced pore structure. Acquisition of plastic precursors from waste streams reduces plastic production cost.

Suitable plastics may be purchased or collected as waste products. A carbonization process may then convert the plastic into a monolithic carbon architecture for use as an electrode active material for batteries and supercapacitors, after it is ground, milled, or otherwise broken down to an appropriate particle size.

Porosity of the carbonized plastic material is mainly a function of the plastic precursor type; carbonization conditions such as temperature, pressure and run time can also affect porosity. Often, the only porosity generated is through the process of pulverization, ball milling, grinding, or another method of particle size reduction. The range of porosity may be between 0-10% for the carbonized plastic material, and 5-50% for the negative electrodes fabricated using the carbonized plastic material. The option of various porosity values is important for producing a material with more specific performance traits, like high rate capability or high energy density.

In an aspect, embodiments of the invention relate to an energy storage device including a negative electrode comprising carbonized plastic.

One or more of the following features may be included. The carbonized plastic may include planar graphene crystals. The carbonized plastic may include planar layers including at least one of graphitic oxide, graphene oxide, and/or combinations thereof. The carbonized plastic may include at least one surface including facets indicating the planar layers.

The carbonized plastic may include a plurality of bubble-induced voids.

The energy storage device may further include a positive electrode, a separator; and an electrolyte, the electrolyte infiltrating the negative electrode, the separator, and the positive electrode. The positive electrode may include carbonized plastic. The electrolyte may include at least one of LiPF₆, LiTFSI, KOH, and/or combinations thereof. The positive electrode may include at least one of metal oxide and/or metal oxide composites.

The plastic may include a mix of graphitic carbon and non-graphitic carbon and at least one of oxygen or graphene oxide. A ratio of graphitic weight to non-graphitic carbon weight may be selected from a range of 0.01:1 to 0.99:1. A weight percentage of oxygen may be selected from a range of 0 wt % to 50 wt %. A weight percentage of graphene oxide may be selected from a range of 0% to 95%. A weight percentage of carbon may be selected from a range of 80% to 100%.

The carbonized plastic may include at least one of graphitic, graphene oxide, graphite oxide, reduced graphene oxide, reduced graphite oxide layers, and/or combinations thereof.

The carbonized plastic may have a porosity of 0-10%, and the negative electrode may have a porosity of 5-50%.

The carbonized plastic may include a particle including at least one of graphitic, graphene oxide, graphite oxide, reduced graphene oxide, reduced graphite oxide layers, and/or combinations thereof, and the layers may define a feathery rippled texture on a surface of the particle.

A crystallinity of the carbonized plastic may be at least one of amorphous hard carbon type, short-order graphitic (turbostratic), a higher degree of crystallinity selected from 20% to 80% crystalline (graphitic), and/or combinations thereof.

A source of the carbonized plastic may be post-consumer plastic.

The electrode may include a freestanding electrode consisting essentially of carbonized plastic.

The electrode may include a slurry-casted electrode, and an active material in the slurry-casted electrode may include the carbonized plastic.

The electrode may be a composite electrode including a conductive additive.

The negative electrode may be a composite electrode including at least one organic polymer binder.

The carbonized plastic may include a carbon purity selected from a range of 50 wt % to 100 wt %.

In another aspect, a method for fabricating a battery or a supercapacitor includes collecting plastic, rinsing the plastic with a liquid to remove residues performing a high-temperature carbonization of the plastic, and fabricating a carbonaceous electrode from the carbonized plastic.

One or more of the following features may be included. The plastic may include at least one of consumer, non-consumer, recycled, non-recycled plastic, or combinations thereof.

The plastic may include at least one of polyethylene terephthalate, polyamides, polycarbonates, polyesters, polyethylenes, polypropylenes, polystyrenes, polyurethanes, polyvinyl chlorides, polyvinylidene chlorides, acrylonitrile butadiene styrenes, polyepoxide trifluorides, polymethyl methacrylates, polytetrafluoroethylenes, phenolics, melamine formaldehydes, urea-formaldehydes, polyetheretherketones, maleimides, polyetherimides, polyimides, plastarches, polylactic acids, furans, silicones, and/or combinations thereof.

Optionally, a very low-temperature heat treatment of the plastic may be performed, e.g., heating the plastic to a temperature selected from a range of 70° C.-250° C.

Fabricating the carbonaceous electrode may include forming a free-standing electrode structure.

Fabricating the carbonaceous electrode may include adding the carbonized plastic to a slurry and slurry-casting.

The carbonaceous electrode may be incorporated into a battery housing or a supercapacitor housing.

A low-temperature heat-treatment of the plastic may be performed, e.g., heating the plastic to a temperature selected from a range of 50 to 450° C. under inert gas.

The high-temperature carbonization of the plastic may include heating the plastic to a temperature selected from a range of 450° C. to 3500° C. under inert gas.

The carbonaceous electrode may be rinsed to remove impurities.

The collected plastic, after the rinsing step and prior to low-temperature heat treatment, may be dissolved or acidified and subsequently re-precipitated.

A polymeric property of the collected plastic may be different after dissolution or acidification, the polymeric property including at least one of shortened chain length, lengthened chain length, crosslinking, chain cleavage, crystallinity, functionalization, and/or combinations thereof.

In yet another aspect, embodiments of the invention relate to an energy storage device including a negative electrode including carbon fibers, each fiber having a diameter selected from a range of 10 nm to 500 μm. The interwoven or nonwoven carbon fibers define a material having hierarchically porous carbon, a crystallinity selected from a range of 0 to 99.999%, and a long-range graphitization with graphitic fibers L ranging from 5 μm to 10 mm. The fibers may be interwoven or nonwoven.

One or more of the following features may be included. The energy storage device may include a positive electrode; a separator; and an electrolyte, the electrolyte infiltrating the negative electrode, the separator, and the positive electrode. The positive electrode may include the interwoven or nonwoven carbon fibers. The electrolyte may include at least one of LiPF₆, KOH, and/or combinations thereof.

The hierarchically porous carbon may include micropores having a diameter of <2 nm, mesopores having a diameter selected from a range of 2 to 50 nm, and macropores having a diameter of >50 nm.

A volume of the micropores may be selected from a range of 1 to 20%, a volume of the mesopores selected from a range of 1 to 20%, and a volume of the macropores selected from a range of 2 to 30%. A diameter of the fiber may be selected from a range of 10 nm to 500 μm.

The negative electrode may be a freestanding electrode formed of the carbon fibers. Alternatively, the negative electrode may be a slurry-casted electrode, and the carbon fibers may be an active material in the slurry-casted electrode. The negative electrode may be a composite electrode including a conductive additive and/or at least one organic polymer binder.

The carbon fibers may include carbon having a purity of >95% by weight. The carbon fibers may include a particulate additive such as at least one of including at least one of microparticles, nanoparticles, nanorods, nanofibers, or nanowires, which may include at least one of silicon, germanium, any carbon allotrope, sulfur, selenium, nitrogen, oxygen, phosphorus, a metal (e.g., tin, aluminum, nickel, and/or copper), any metal oxide, any metal phosphate, any metal sulfides, or combinations thereof.

The positive electrode may include at least one of metal oxide and/or a metal oxide composite.

In still another aspect, embodiments of the invention relate to a method for fabricating an energy storage device, the method including liquefying recycled bottles comprising a plastic by at least one of melting the plastic and dissolving the plastic in a solvent. The liquefied plastic is delivered to a conductive tip. A high voltage is applied to the conductive tip to extrude plastic fibers therefrom. The extruded plastic fibers are collected on a collection substrate. The plastic fibers are pyrolyzed. An electrode is formed for the energy storage device from the pyrolyzed plastic fibers.

One or more of the following features may be included. The plastic may include at least one of polyethylene terephthalate, polyamides, polycarbonates, polyesters, polyethylenes, polypropylenes, polystyrenes, polyurethanes, polyvinyl chlorides, polyvinylidene chlorides, acrylonitrile butadiene styrenes, polyepoxide trifluorides, polymethyl methacrylates, polytetrafluoroethylenes, phenolics, melamine formaldehydes, urea-formaldehydes, polyetheretherketones, maleimides, polyetherimides, polyimides, plastarches, polylactic acids, furans, silicones, or combinations thereof.

The plastic may be liquefied by melting at a temperature of at least 250° C. The plastic may be liquefied by dissolving in the solvent, such as in triflouroacetic acid (TFA).

The conductive tip (i) may include at least one of a brass alloy, a stainless steel alloy, an aluminum alloy, and/or a combination thereof, and (ii) define a fluidic pathway.

The liquefied plastic may be delivered to the conductive tip by a syringe pump.

The electrode may be a carbon anode. The electrode may be a composite electrode.

The energy storage device may be a battery or a supercapacitor.

The plastic fibers may be pyrolyzed at a temperature selected from a range of 500° C. to 3500° C. under inert gas.

The plastic fibers may be pyrolyzed at a high temperature ramp selected from a range of 0.1° C. to 1000° C. per second.

Pyrolysis of the PET fibers may include inserting the PET fibers into a quartz tube furnace into a heating zone for rapid pyrolysis. Particles including at least one of microparticles, nanoparticles, nanorods, nanofibers, or nanowires comprising at least one of silicon, germanium, any carbon allotrope, sulfur, selenium, nitrogen, oxygen, phosphorus, a metal (e.g., tin, aluminum, nickel, or copper), any metal oxide, any metal phosphate, a metal sulfide, or combinations thereof may be loaded into the liquefied plastic. The applied voltage may be selected from a range of 5 kV to 40 kV.

In another aspect, embodiments of the invention relate to an energy storage device including a negative electrode including a plurality of interwoven or nonwoven carbon fibers. The fibers have a crystallinity in a range from 0 to 99.999%, and long-range graphitization within graphitic fibers length L ranging from 1 μm to 10 mm, and a core-shell structure. The carbon fibers may be interwoven, nonwoven, or combinations thereof.

One or more of the following features may be included. The energy storage device may include a positive electrode, a separator, and an electrolyte, with the electrolyte infiltrating the negative electrode, positive electrode, and separator.

The positive electrode may include the carbon fibers.

The hierarchical porous carbon may include micropores with diameters of <2 nm, mesopores of 2 to 50 nm, and macropores of >50 nm.

The energy storage device may comprise micropore volume of 1 to 20% of total pore volume, the mesopore volume of 1 to 20% of total pore volume, and volume of macropores of 2 to 30% of total pore volume.

Each fiber may have a diameter selected a from range of 10 nm to 500 μm.

The negative electrode may be freestanding and include only the carbon fibers. The negative electrode may also be slurry-casted, with the carbon fibers being an active material. The negative electrode may be a composite electrode including a conductive additive that includes at least one organic polymer binder and/or at least one organic polymer binder.

The carbon fibers may include carbon having a purity of 95 to 100% by weight. The carbon fibers may further include particulate additives comprising at least one of microparticles, nanoparticles, nanorods, nanofibers, or nanowires comprising at least one of silicon, germanium, any carbon allotrope, sulfur, selenium, nitrogen, oxygen, phosphorus, a metal (e.g., tin, aluminum, nickel, or copper), any metal oxide, any metal phosphate, any metal sulfide, or combinations thereof.

The electrolyte may include at least one of lithium hexafluorophosphate (LiPF₆), potassium hydroxide (KOH), and/or combinations thereof. The positive electrode may include at least one of a metal oxide, a metal oxide composite, and/or combinations thereof.

In still another aspect, embodiments of the invention relate to a method for fabricating an energy storage device. Plastic is liquefied by at least one of melting the plastic or dissolving the plastic in a solvent or acid. The liquefied plastic is delivered to a conductive tip. A high voltage is applied to the conductive tip to extrude plastic fibers therefrom. The extruded plastic fibers are collected on a collection substrate. The fibers are impregnated with iron chloride (FeCl₃) by immersion in a FeCl₃ solution and drying of the plastic fibers. The FeCl₃-impregnated fibers are coated with polypyrrole by exposure them to pyrrole vapors. Excess FeCl₃ and/or iron is removed from the polypyrrole-coated plastic fibers. The polypyrrole-coated plastic fibers are pyrolyzed. An electrode for the energy storage device is formed from the pyrolyzed plastic plastic fibers.

One or more of the following features may be included. The plastic may include at least one of polyethylene terephthalate, polyamides, polycarbonates, polyesters, polyethylenes, polypropylenes, polystyrenes, polyurethanes, polyvinyl chlorides, polyvinylidene chlorides, acrylonitrile butadiene styrenes, polyepoxide trifluorides, polymethyl methacrylates, polytetrafluoroethylenes, phenolics, melamine formaldehydes, urea-formaldehydes, polyetheretherketones, maleimides, polyetherimides, polyimides, plastarches, polylactic acids, furans, silicones, or combinations thereof. The plastic may be liquefied by melting at a temperature of at least 250° C. The plastic may also be dissolved in the solvent, such as trifluoroacetic acid (TFA).

The conductive tip may include at least one of a brass alloy, stainless steel allow, aluminum alloy, and/or combination thereof, and defines a fluid pathway. The liquefied plastic may be delivered to the conductive tip by a syringe pump.

The electrode may be a carbon anode, or a composite electrode.

The energy storage may be a battery or a supercapacitor. The plastic fibers may be pyrolyzed at a temperature range selected between 450° C. and 3500° C. under inert gas. The plastic fibers may be pyrolyzed at a temperature ramp ramp selected from a range of 0.9° C. to 600° C. per second.

Pyrolysis of the plastic fibers may include inserting the plastic fibers into a quartz tube furnace into a heating zone for rapid pyrolysis. An applied voltage may be selected from a range of 5 kV to 40 kV. Particles may be loaded into the liquefied plastic. The particles may include at least one of microparticles, nanoparticles, nanorods, nanofibers, or nanowires comprising at least one of silicon, germanium, any carbon allotrope, sulfur, selenium, nitrogen, oxygen, phosphorus, a metal (e.g., tin, aluminum, nickel, or copper), a metal oxide, a metal phosphate, a metal sulfide, or combinations thereof.

The FeCl₃ solution may include at least one solvent such as water, a polar organic solvent, and/or combinations thereof.

The FeCl₃ solution may include a concentration of FeCl₃ of between 0.01 to 6M FeCl₃.

The pyrrole vapors may be emitted from a container of liquid pyrrole monomer disposed within a chamber in which the FeCl₃-impregnated plastic fibers are disposed.

The excess FeCl₃ or iron may be removed from the polypyrrole-coated plastic fibers by at least one of washing or etching.

A thickness of the polypyrrole coating may range from 1 nm to 30 μm.

Pyrolyzing the polypyrrole-coated plastic fibers after excess iron or FeCl₃ are removed may produce a core-shell carbon structure.

The pyrolyzed fibers may also comprise dispersed particles including at least one of microparticles, nanoparticles, nanorods, nanofibers, or nanowires comprising at least one of silicon, germanium, any carbon allotrope, sulfur, selenium, nitrogen, oxygen, phosphorus, a metal (e.g., tin, aluminum, nickel, or copper), any metal oxide, any metal phosphate, any metal sulfide, or combinations thereof.

### BRIEF DESCRIPTION OF DRAWINGS

FIGS. 1a and 1b are SEM micrographs of carbonized plastic formed in accordance with embodiments of the invention. [ADD 1a and 1b inside the figures.

FIG. 2 is a graph illustrating Raman spectroscopic characterization of carbonized plastic material at both 800° C. and 1000° C. in two select locations, prepared in accordance with embodiments of the invention.

FIGS. 3a and 3b are the EDS characterization and elemental mapping of carbon onto the carbonized plastic carbon material, respectively, prepared in accordance with embodiments of the invention.

FIG. 4 is a graph illustrating the powder X-ray diffraction spectrum of carbonized plastic after heat treatment with a pyrolysis temperature of 2500° C., in accordance with embodiments of the invention.

FIG. 5 is a schematic diagram illustrating the concept of converting recyclable thermoplastics into battery materials, in accordance with an embodiment of the invention.

FIGS. 6a and 6b is a schematic diagram and a photograph, respectively, illustrating the electrospinning method of PET fabric production, in accordance with an embodiment of the invention.

FIG. 7 is a schematic diagram illustrating the flow of production of carbon fibers of varying crystallinity, and used in Li-ion cells.

FIGS. 8a-8d are SEM micrographs showing carbonized polypyrrole (Ppy)-coated PET fibers (8a-8b) and carbonized Ppy-coated polyacrylonitrile (PAN) fibers (8c-8d), prepared in accordance with embodiments of the invention.

FIG. 9 is a graph illustrating Raman spectroscopic characterization showing spectra of carbonized Ppy-coated PET fibers after pyrolysis temperature of 800° C. (1 and 2) and 1000° C. (3 and 4).

FIGS. 10a-10d are SEM micrographs of Si particle-loaded carbonized Ppy-coated PET fibers, showing outer fiber morphology (10a-10b) and internal fiber morphology, including the housing of Si particles (10c-10d).

FIG. 11 is a graph showing discharge profiles (C/5 lithiation) of anodes comprising pyrolyzed PET bottle plastic after 800° C. pyrolysis, 1000° C. pyrolysis, and pyrolyzed Ppy-coated PET fibers after pyrolysis at 1000° C., formed in accordance with embodiments of the invention.

### DETAILED DESCRIPTION

As used herein, “carbonized plastic” means a carbonaceous product produced from the pyrolysis of various plastics. It may be produced using processes described herein, and functions as described in the claims. Carbonized plastic is no longer plastic, whereas the precursor for carbonized plastic is plastic.

As used herein, “pyrolysis” and “carbonization” means the process of removing nearly all elements besides carbon from a material.

As used herein, the term “graphitic layers” means “graphene layers,” i.e., layers of single-atom thick carbon in a planar crystal (many layers begin to form what is known as graphite).

Plastics, thermoplastics and other plastics such as PET and other related materials can serve as ideal precursors to high performance carbon materials for use in Li-ion anode electrodes, as active material. Embodiments of the invention enable a significant performance increase in lithium-ion batteries and supercapacitors through the conversion of plastics to carbon-based electrodes.

Embodiments of the invention involve collection of plastic either upstream or downstream of material consumption. To collect the plastic, it may either be sourced from waste streams, at businesses or residential areas, immediately after production, or pre/post consumption. These plastics can also be obtained from well known recycling plants. The plastics are typically ready for a carbonization step and do not require extensive material preparation, after which the pyrolytic carbon product can then be used as an active material in batteries, conductive additive, or as supercapacitor electrode material. The pyrolytic product discussed herein may either be used as a freestanding electrode monolith, or can be further mixed into an electrode slurry for casting electrodes with binder and conductive additive.

The product produced from the processes described herein can also be utilized in virtually all of the applications normally and traditionally reserved for graphite, since the product discussed herein has a composition very similar to that of graphite, albeit with different crystallinity, order, purity, and morphology. Examples of other industries in which this material may be applied include the steel making industry (electric arc furnaces and electrodes), high-temperature graphite crucibles, solid lubricants, electronically conductive inks, interfaces and tools, engineering tools and pencils, additives in structural composite materials, etc.

Prior to pyrolysis of the plastic, a very low temperature heat-treatment may be performed on the plastic during which the material, after being placed into the heating zone of a furnace or heating apparatus, is exposed to temperature of between 70-250° C. This may densify and alter the properties of the plastic prior to pyrolysis, thereby changing the properties of the pyrolytic product of the plastic. This very low heat-treatment may be done in ambient atmosphere or under inert gas at, e.g., a temperature range of 70-250° C. for a time ranging from, e.g., 20 minutes to 8 hours. Also optionally a low temperature heat-treatment of the plastic may be performed prior to high-temperature carbonization. This low temperature heat-treatment may be carried out at between 50-450° C., under inert gas. This step is to partially or fully carbonize the plastic prior to high-temperature carbonization, during which the crystal structure and microstructure is further altered. The low temperature heat-treatment may done at, e.g., a temperature range of 50-450° C. for a time ranging from, e.g., 20 minutes to 12 hours.

Pyrolysis treatments typically happen under inert atmosphere (argon, nitrogen or helium gas) in a heating chamber or furnace, using temperatures between 200° C. to 3500° C., with the temperatures depending on the material precursor (numerous types of plastics may be processed as discussed herein). This heat treatment may be carried out for various lengths of time, from 30 minutes to 3 days, depending on the level of precursor dehydration, plastic type, etc. In some cases a mixture of inert gas and hydrogen gas may be used to keep a reducing atmosphere; this may also help strip out excess oxygen in the material. The inert gases used in this process may be, e.g., nitrogen, helium, neon, argon, krypton, or xenon. After pyrolysis, the material is typically rinsed with a liquid such as water and/or a polar organic solvent such as isopropanol, ethanol, or acetone to remove any excess residues and artifacts. The plastics, after pyrolysis, tend to form pores of multiple size regimes: micropores, mesopores, and macropores (<2 nm diameter, between 2 nm and 50 nm, and >50 nm diameter respectively), depending on the plastic precursor type. The varying plastic type precursor can lead to slightly different carbon properties.

After pyrolysis, the resulting carbon material has a structure which may be described as monolithic layered carbons. Electron microscopy shows, after crushing and powderizing, particles that have layered properties. In the z-direction, the particle edges show several layers (on the order of hundreds of layers or more), extending through particles with diameters of 200 nm to 200 μm. The layers have strong graphitic and/or graphene oxide nature. The morphology of the monolithic carbons is formed during heating, wherein the plastic melts (above ˜250° C.), and gasification begins the onset of bubbling. The bubbling causes voids to form and the size range of the bubble-induced voids is 1 μm-100 μm. The bubble-induced voids and the formation of these bubbles contributes to the unique macro and microstructure that results from pyrolysis of these specific plastics.

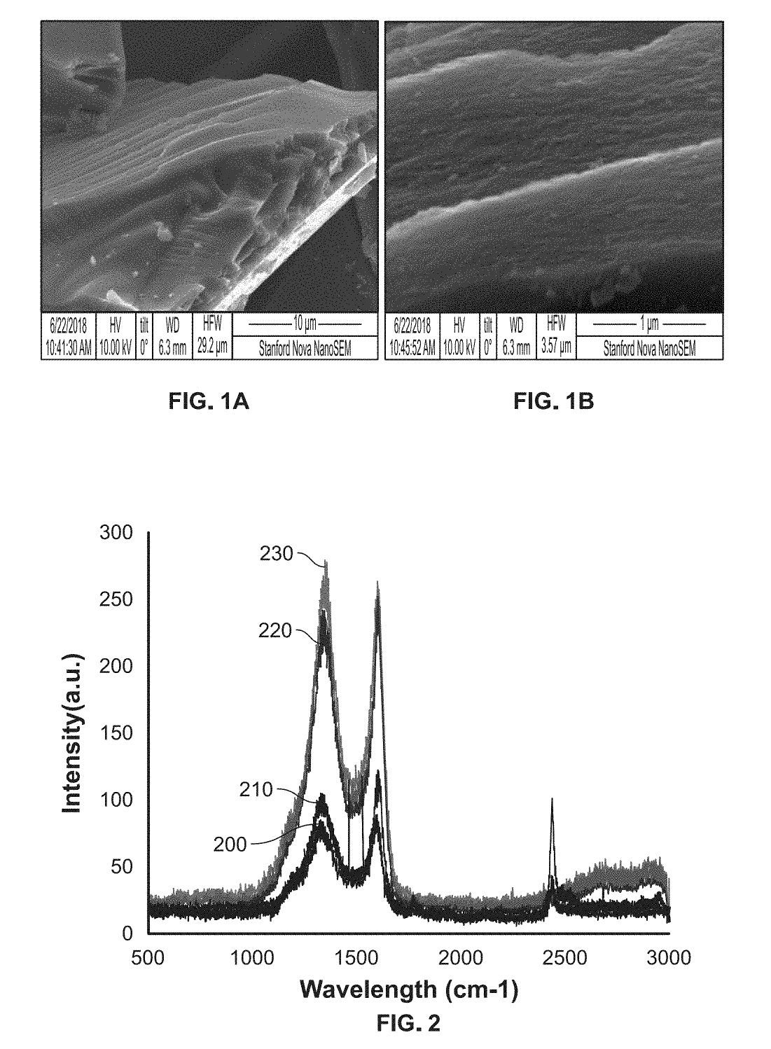

The carbonaceous products have already been shown to have excellent stable cycling properties in Li-ion batteries, with over 200 cycles without significant capacity fade. The pyrolysis conditions and plastic precursor type can modify/affect the electrode performance. Referring to FIGS. 1a and 1b, SEM micrographs at lower magnification and higher magnification, respectively, have confirmed the aforementioned structure, i.e., that of bulk carbon consisting of several layers of graphene or graphene oxide, as manifested by the surfaces of ground particles where planar crystalline surfaces produce a “feathery” texture. The rippling feathery texture indicates planar edges of graphene/graphene oxide layers. The samples used for the SEM micrographs in FIGS. 1a and 1b were prepared by first washing plastic water bottles in water and isopropanol and drying ambiently. The bottles were then cut up into ˜2 cm² pieces and placed into a quartz boat, which was loaded into a tube furnace. The tube furnace was then filled completely with argon gas to maintain an inert atmosphere. The temperature of the heating zone of the furnace was ramped to 800° C. and held at 800° C. for 1 hour. The furnace was then allowed to cool slowly. Once at room temperature, the black, carbonaceous material remaining in the quartz boat inside the furnace was collected, and SEM analysis was performed, yielding the images in FIGS. 1a and 1b.

Raman spectroscopy was used to probe the material properties of the carbonized plastic material as well. Referring to FIG. 2, two spectra are shown for the material after processing at both 800° C., 200,210, and 1000° C., 220, 230 (a Raman spectrum was captured at two locations for each sample). In the spectra, it can be seen that the crystallinity is enhanced, and longer-order graphitic crystallites are forming and becoming more aligned. This is due to the fact that the peaks are more intense (D and G, i.e., the peaks at ˜1300 cm⁻¹ and 1650 cm⁻¹, respectively) and the broader, less intense peaks between 2500-3000 cm⁻¹ begin to manifest. This indicates that as processing temperature increases from 800° C. to 1000° C., the material becomes “more” graphitic and becomes what is known as “turbostratic.” Continuing up this trend, it can be logically inferred that high crystallinity can be achieved at even higher temperatures, creating a material closely resembling or exactly the same as graphite.

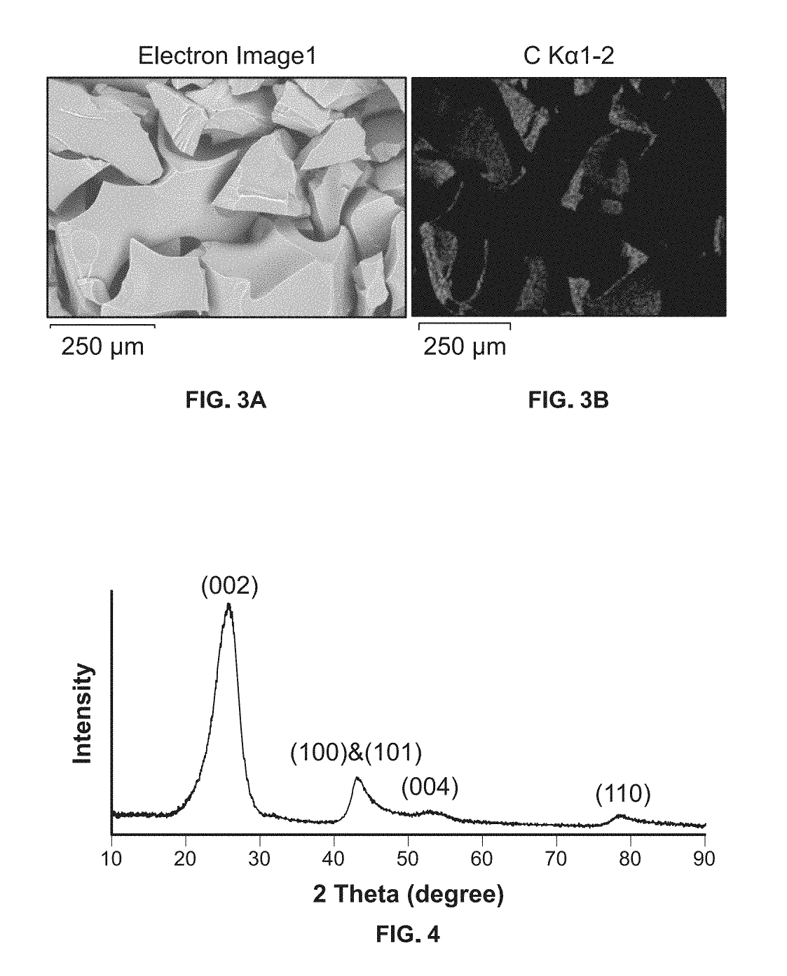

FIG. 3a shows a scanning electron micrograph, and FIG. 3b shows a corresponding X-ray energy dispersive spectroscopy (EDS) elemental mapping of carbon across the electron image, which also shows the morphology of carbonized plastic material as-synthesized in accordance with an embodiment of the invention. The image conveys the distribution of carbon across a carbonized plastic particle as well as the structure of the material before processing into a slurry or electrode; at this point the material is no longer plastic, but has been pyrolyzed at 1000° C.

Powder X-ray diffraction analysis, shown in FIG. 4, was carried out on carbonized plastic material that was heat treated at a pyrolysis temperature of 2500° C.; the results show that there is a mix of graphite and reduced graphene oxide (rGO). This aligns closely with what is expected at this temperature; graphitization is apparent from the reflections indicated in the spectrum, while the intensity and enlarged peak at ˜40 indicate some rGO nature.

It is important that more sustainable energy storage devices are produced in mass manufacturing, thereby requiring more eco-friendly processes and materials. Cost is an important factor for battery manufacturers; calculations have shown that use of plastic/plastic bottle-based carbon anodes can reduced costs by over 2× per mAh/g in comparison to the incumbent, graphite. This is in large part due to the reduction in raw material costs, but also due to relatively good cycling performance in Li-ion batteries.

The electrodes produced from plastics (postconsumer or non-post consumer) in accordance with embodiments of the invention exhibit a variety of structural features, ranging from monolithic, non-porous carbons to highly porous particles. The post-pyrolytic carbon product can easily be broken down to appropriate particle sizes for use in Li-ion electrodes through ball-milling or other methods. The pores in the structures range from 2 nm-50 μm, depending on the material precursor. Initial Raman characterization shows that the material exhibits graphitic properties, strong graphene and graphene-oxide like nature; much of the oxygen can be reduced through higher pyrolysis temperatures and longer run times or by heating the material with hydrogen gas between 450-3500° C. Graphite is actually multiple layers of graphene stacked vertically, forming 3D crystals. The final oxygen content may be in a range from 20%-0%. The composition is mainly carbon (80-99.999%), and other heteroatoms (20-0.0001%). The crystallinity of the material ranges from amorphous hard carbon type, to short-order graphitic (turbostratic), to higher degrees of graphitic crystallinity (20-80%), and, most often, few layer graphene and/or graphene oxide. The number of layers in the material may also vary, because the gasifying process causes bubbling and thus fluctuating thicknesses of the resultant bulk carbon. For example, the carbonized plastic material may contain, either in the form of graphitic or graphene oxide-like layers, characteristics of crystalline carbon with a layer structure of (or a combination of):
a. single layer
b. single layer and few layer
c. single layer and multilayer
d. few layer
e. few layer and multilayer; or
f. multilayer
   The above combinations indicate the possible variations in the amount of layers of graphene and/or graphene oxide in the material. “Layer structure” here refers to the number of graphene and/or crystalline layers exhibited by the material, and the list a-f details the possible combinations of different layer structures exhibited by the material. “Few layer” refers to a crystal or crystallite in the material containing between 2 to 10 atomic layers. “Single layer” refers to 1 atomic layer. “Multilayer” refers to greater than 10 atomic layers.

To pyrolyze the plastic samples, typically a chemical vapor deposition (CVD) system, tube furnace, specialty gases, and flow controllers are used. Other types of furnaces may also be used, as long as the temperature limit is sufficient for carbonization and the system can be filled with inert gas. Other heating chambers such as flash carbonization furnaces, IR furnaces, or furnace chambers can be used. Additional types of advanced furnace systems may be used, such as batch ovens, vacuum front loading furnaces, high temperature annealing furnaces, plasma heaters, laser furnaces, etc. with temperature ranges from 100-3500° C. Various types of furnaces may achieve a faster heat treatment, or enable higher temperatures while maintaining stability.

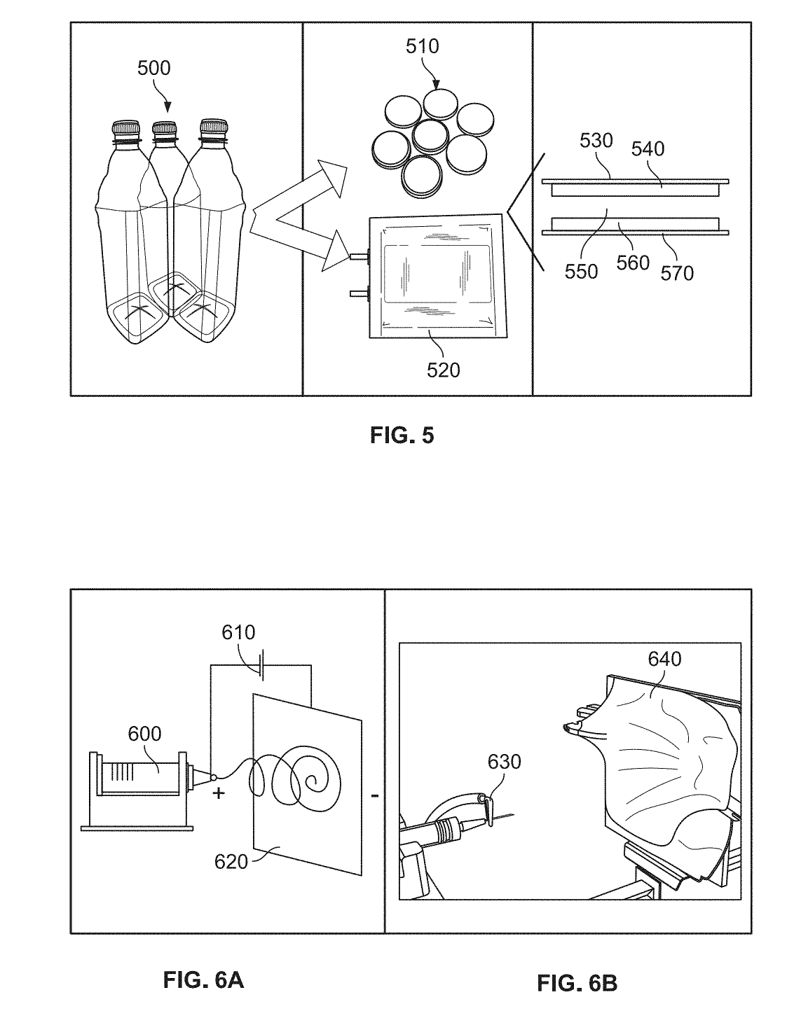

Referring to FIG. 5, an exemplary process for fabricating electrodes from carbonized plastic material for use in Li-ion batteries and supercapacitors, in accordance with embodiments of the invention, is as follows:

1. Plastics are collected from any of the sources described above, and either separated according to plastic source or type, or completely combined. An example of a plastic source is from discarded water bottles 500.

2. A high-temperature heat treatment under inert gas (e.g., N₂, Ar, and/or He) is carried out to promote polymer decomposition and subsequent carbonization (pyrolysis). This step may be done in a furnace, ramped to between 450-3500° C. and held at the elevated temperature for between 30 minutes and 5 hours.

3. The pyrolyzed plastic is then collected from the furnace and washed very thoroughly with DI or ultrapure water until the pH reaches ˜7. This may be done using dilution-centrifugation method or gravity/vacuum-filtration method.

4. The washed pyrolyzed plastic may be vacuum dried for 30 minutes to 24 hours, e.g., overnight e.g., at a temperature between 90-120° C., until completely dry. The dried product may then be collected and pulverized into a fine powder; this may be done using a mortar and pestle, a ball mill, or other methods of powderizing. A particle filter may be used to obtain a small particle size distribution.

5. The powder may be mixed into a slurry containing a solvent/carrier fluid (water, alcohol, glycol, n-methyl pyrrolidone, acetonitrile, etc.), a polymer binder (polyvinylidene fluoride, carboxymethyl cellulose, polystyrene butadiene rubber, polyacrylic acid, sodium alginate, etc.), and/or a conductive additive (carbon black, C60, graphite, carbon nanofibers, etc.) in various ratios and concentrations.

6. The slurry is mixed thoroughly using magnetic stirring, agitation, mechanical homogenization, ultrasonication, and/or vacuum mixing.

7. The slurry may be cast onto a metal foil such as copper or nickel, or onto a copper or nickel foam, or other conductive substrate, and allowed to dry ambiently or under heat and vacuum.

8. After drying, the cast dried slurry forms functional electrodes and can be cut to various sizes and incorporated into the battery or supercapacitor as described elsewhere.

9. Alternatively, other than slurry-casting, the as-prepared material from Step 4 may also be incorporated directly into the battery or supercapacitor as a freestanding structure, and without the use of the slurry constituents described in Steps 5-8.

10. As another option, silicon in various forms (nanoparticles, microparticles, nanorods, nanofibers, nanowires, etc.) and in various weight ratios, may be incorporated into the material by using dry ball milling during Step 4, or by adding to the slurry in Step 5. Other materials may be added in a similar fashion, including at least one of microparticles, nanoparticles, nanorods, nanofibers, or nanowires, which may include silicon, tin, germanium, a carbon allotrope, sulfur, selenium, nitrogen, oxygen, phosphorus, a metal (e.g., tin, aluminum, nickel, and/or copper), a metal oxide, a metal phosphate, a metal sulfide, and/or combinations thereof, to enhance the storage capacity of the composite material.

11. After the electrodes are finished, either as freestanding electrodes or after the slurry-casting method, they may be incorporated into an energy storage device (battery or supercapacitor), in various form factors such as coin cells 510 or pouch cells 520. In a battery, the electrode described above acts as the negative electrode, which is welded to a current collector (copper or nickel), and is added as a layer in a stack of alternating layers of negative electrode, separator, and positive electrode (the positive electrode being welded to a current collector (e.g., aluminum)). The number of layers may vary, and the form factor of the battery may vary. In this case, the negative electrode is the electrode that includes the carbonized plastic, i.e., carbon product that was produced from plastic precursor and then pyrolyzed (see process section). The negative electrode can be produced from any industrial, pre- or post-consumer plastic, and which ultimately produces a structure of bulk carbon with numerous layers (>2 layers) of graphene, graphene oxide (GO) or reduced graphene oxide (rGO); by virtue of the existence of multiple layers, graphite may exist. The entire device interior is flooded with liquid electrolyte, or else a solid electrolyte is used. The electrolyte may be based on LiPF₆ or LiTFSI for a Li-ion battery. For a supercapacitor, the electrode described above is included as both the negative and positive electrode, with the same architecture described for the battery, and a KOH electrolyte may be used. The positive electrode may include battery active materials such as metal oxides, and sulfur or oxygen-based materials. The typical internal architecture of a lithium-ion battery includes a positive current collector 530, positive electrode 540, insulating separator 550, negative electrode 560, and negative current collector 570.

An alternative step in processing PET-derived carbons for energy storage is to acidify, or dissolve the plastic in an acidic solvent such as trifluoroacetic acid (TFA), thereby forming a solution of PET (or similar plastic). In such a solution, TFA (or other acid or solvent) may alter the chain length of PET (or similar plastic) or chemical structure. The PET, or other dissolved/acidified plastic, can then be precipitated through removal of solvent via evaporation, or through addition of water to the solution. This step is referred to herein as “re-precipitation”). The re-precipitated polymer (plastic) has a new degree of crystallinity, chain length, functionalization, and/or other various polymeric properties, with respect to the plastic pre-dissolution/acidification.

This process can be carried out with any other plastic or thermoplastic, including polyamides, polycarbonates, polyesters, polyethylenes, polypropylenes, polystyrenes, polyurethanes, polyvinyl chlorides, polyvinylidene chlorides, acrylonitrile butadiene styrenes, polyepoxide trifluorides, polymethyl methacrylates, polytetrafluoroethylenes, phenolics, melamine formaldehydes, urea-formaldehydes, polyetheretherketones, maleimides, polyetherimides, polyimides, plastarches, polylactic acids, furans, silicones, and other non-consumer and post-consumer plastics.

Any acid that can dissolve these plastics may be used in the slurry, such as HCl, any organic fluorinated acids, strong acids or weak acids, and non-acidic solvents. Examples of other suitable acids include hydrochloric acid, hydrofluoric acid, hydroiodic acid, hydrobromic acid, etc.

The altered properties of the plastic through dissolution/acidification and re-precipitation may also alter its carbonization properties, if it is treated as a precursor to high-purity carbon through the pyrolysis/carbonization described above. Thus, the pyrolytic product of this re-precipitated plastic has new properties as compared to carbonized plastic without any dissolution/acidification. The temperature for graphitization may be lowered compared to un-dissolved/un-acidified plastic, and thus, the production of a graphite-like carbon product can be done at a lower temperature using dissolved/acidified and re-precipitated plastic. The yield may also be altered, either having a lower or higher yield as compared the undissolved alternative. The volume of gaseous products usually manifested during carbonization of plastic is also altered if using the acidified/dissolved and re-precipitated plastic.

In experiments conducted at a temperature of 1000° C., during the process of carbonizing the acidified/dissolved and re-precipitated plastic, a thin carbon film forms on the internal surfaces of the furnace tube, essentially forming a carbon coating. This does not occur without the dissolution/acidification and re-precipitated process of the plastics. Therefore, un-elucidated mechanisms with this specific process lead to altered carbonization behavior. After pyrolysis of this material, it looks visually mirror-like on the surface, very similar to the way natural graphite crystals look, i.e., highly reflective and shiny.

The materials described herein may be characterized using electron microscopy techniques, X-ray irradiation including energy-dispersive X-ray spectroscopy (EDS) and powder X-ray diffraction (XRD), Raman spectroscopy, Fourier-transform infrared spectroscopy (FTIR), and electrochemical characterization techniques including cyclic voltammetry (CV), electrochemical impedance spectroscopy (EIS), and potentiostatic/galvanostatic charge/discharge testing using battery cyclers. Thus, the chemical and structural compositions can be correlated to battery performance as characterized through electroanalytical techniques. Of most importance is the capacity, voltage, and time parameters during charge/discharge testing. These tests may be conducted in battery cells, both in the half-cell format (lithium metal vs. pyrolyzed plastic carbon electrodes), as well as full-cells (pyrolyzed plastic carbons vs. commercial cathode materials). Symmetrical supercapacitors (two of the same electrode) may also be fabricated and tested using this material. The batteries fabricated from these materials can be in coin, pouch, or cylindrical form factors.

The processes described herein address battery active material cost, performance, and impact on the environment. Rather than synthesizing expensive polymers to form graphite or mining limited resources for natural graphite, materials here are converted to porous, microstructured and nanostructured carbons, saving toxic waste in the form of reaction byproducts and solvents. The materials mentioned herein are less costly to produce and may perform nearly on par with graphite or better in some dimensions such as capacity, energy density, cycle life, rate capability, and cost significantly less (˜2× or less cost).

The described material is produced from plastic bottles or any other sources of plastic, whether industrial, pre-consumer or post-consumer, recycled or non-recycled, which generate an array of carbonaceous structures as a result of pyrolysis. Thus, these materials have varying degrees of crystallinity, porosity, and proportions of graphitic, graphene or graphene oxide nature.

A simplified summary of the process flow for producing carbonized plastic for various purposes, including as a battery anode active material, is provided below. In particular, the carbonized plastic material synthesis process and the output material, as well as the utilization of the specific input material (plastics from various sources) is described in detail above, and more succinctly and summarily below.
1. Plastic is collected from plastic suppliers, recycling companies, companies that generate plastic or plastic waste, or obtained through recycling pathways such as a post-consumer material.
2. The plastic is rinsed with a liquid, such as water and/or isopropanol, or another mild solvent to remove residues and adhesives.
3. The plastic may optionally, after the rinsing step, go through a dissolution/acidification and re-precipitation step, wherein the plastic is liquefied and then precipitated to a solid form with altered polymer properties.
4. The rinsed plastic can undergo a lower temperature heat treatment for densification or stabilization, between (30 minutes-600 minutes, 50-450° C.), inside a quartz tube furnace or a box furnace, or another type of drying oven. This step is to reduce volatility before ramping to high temperature, such as in Step 6, and is optional.
5. The plastic is loaded into a quartz tube furnace, sitting inside of a weigh boat. Any other type of furnace with an inert atmosphere is also suitable.
6. The furnace is filled with inert gas, such as argon, nitrogen or helium.
7. The quartz tube is heated to between 450-3500° C. (high-temperature heat treatment) and held for various lengths of time (30 mins to 6 hours), followed by cooling.
8. The carbonized plastic (after high-temperature heat treatment) is collected, thoroughly rinsed with water and/or isopropanol or other mild purification agents such as HCl or alcohols.
9. After sufficient vacuum drying, the material is used directly as free-standing electrodes for batteries or supercapacitors, or it is blended in a slurry to be slurry-cast onto foils as traditional electrodes.
10. Electrodes are utilized in various energy storage devices.

### Carbon Fibers

The carbon fiber-based electrode materials produced from the materials and processes described herein may be utilized in both the negative and positive sides of secondary batteries, and are also applicable to electrodes in primary batteries. For secondary (rechargeable) batteries, the carbon fibers themselves can serve as a high capacity anode (negative electrode) in Li-ion and other battery chemistries. They may also serve as the conductive scaffolding for cathode (positive electrode) active materials on the cathode side of Li-ion batteries; for example, the resulting carbon fibers can be impregnated with metal oxides, metal oxide composites, sulfur, a metal, or other electroactive conversion materials either in-situ or post-fabrication. The metal or metal oxide may include at least one of tin, germanium, lead, a semimetal, a transition metal, an alkaline earth metal, or an alkali metals These types of architectures and materials resulting from recycled bottles and using electrospinning improve energy density and cycle life several fold through control of the micro- and nanostructures of these energy storage electrodes.

The parameters that need to be selected for electrospinning a material (i.e., to make it possible to electrospin the material) are: solution polymer concentration (e.g., PET solution polymer concentration), solvent system ratios, flow rate, applied voltage, and electrospinning distance (between tip and collector). The goal during the parameter selection process is to produce fibers with a small diameter, while also maintaining a small diameter distribution. Once parameters are selected, a nanofiber-based fabric can be spun; preferably, for practicality, the fabric is spun to an overall thickness of approximately 20 μm-2 mm.

A method of forming an electrode in accordance with embodiments of the invention may include the following steps. First, recycled plastic is recovered or collected and washed with DI H₂O, then dried statically or under vacuum. PET is used an exemplary plastic, although many other suitable plastics may be used as well. The samples are pulverized and broken down using blenders or high-power shredders, after which they are dissolved in an appropriate solvent for an electrospinning solution (e.g., 0.05-500 mg/mL concentration) (for PET in TFA, the concentration was 1 g/mL; this may change using different solvents), or melted at or near 250° C. Other solvents that may be used are dichloromethane (DCM), toluene, benzene, xylene, combinations of polyaromatic hydrocarbons, chloroform, etc.

At this step, particle additives may also be mixed in with the solution or melt. These particles can be made of at least one of microparticles, nanoparticles, nanorods, nanofibers, or nanowires, which may include silicon, germanium, a carbon allotrope, sulfur, selenium, nitrogen, oxygen, phosphorus, a metal (e.g., tin, aluminum, nickel or copper), a metal oxide, a metal phosphate, a metal sulfide, and/or combinations thereof. The loading of these particles into the final material may be between 0.01-90% by weight. These particles are added by simply mixing their powders into the solution or melt, so that when electrospinning occurs, the particles are included in the resulting fibers. The loading in the fibers can be controlled by the loading in the melt or solution before electrospinning.

Next, referring to FIG. 6a, the solution or melt is loaded into a syringe 600, which is mounted onto a syringe pump. The syringe is connected to a conductive tip, or is connected to a plastic or metal tubing with a conductive tip on the end. Leads of a power supply 610 (ex: WYS-30-1 type high-voltage power supply) are connected to both the conductive tip, and a collection substrate 620 (separate from the pumping system and syringe). A flow rate is then set on the pump (e.g., 1 μL/min-1 mL/min), and the pump is activated, pushing the PET melt or solution toward the conductive tip. A Taylor cone is formed at the tip, at which point the power supply is activated (1 kV-50 kV), and PET fibers are extruded from the melt or solution and collected on the substrate as a woven or nonwoven fabric 640 over time, as depicted in FIG. 6b. The power supply lead connection to the syringe tip, enabling electrical polarization, is also depicted in FIG. 6b.

Parameters for the heat-treatment phase are then selected. Here, the procedure for carbonization of the fabric is established in terms of fiber diameter, crystallinity, porosity, additive composition and concentration, and overall fabric thickness. During carbonization, the conditions of the furnace need to be anoxic (oxygen replaced with inert gas, such as N₂, Ar, or He). For effective pyrolysis of the PET fibers containing particulate additives, such as metal oxide particles, silicon particles, silicon oxide particles, tin particles, etc., the electrospun fibers may be stabilized through a lower-temperature heat-treatment (between 250-500° C.), to enhance the mechanical and electronic properties of the resulting carbon fibers before a high temperature heat treatment. However, a preferred pyrolysis of the fibers (with or without particle additives) is carried out very rapidly, bringing the sample temperature from room temperature to a temperature selected from the range of 300-3500° C. within 3 seconds-5 minutes. This is to avoid local melting due to the glass transition temperature of PET material (the temperature is held for between 3 minutes and 3 hours). Using fast ramp rate, as such, allows the temperature to surpass the glass transition temperature (T_{g}) of the PET without allowing it to melt (T_{g} for PET is between 67-81° C., depending on crystallinity).

To promote pore formation and further increase surface area, the carbon fabric may be first subjected to a KOH-activation. This process involves submerging the fabric in a KOH solution (0.1-6M) for between 30 minutes-12 hours to soak. After the fabric containing KOH solution fully dries (under vacuum or statically), the fabric is placed back into a furnace and heated to 300-3500° C. for between 3 minutes and 3 hours. After the final product is washed with DI H₂O and alcohol, and dried, it is incorporated in the supercapacitor or battery as an electrode. A supercapacitor is assembled in generally the same fashion as a battery, except both electrodes are made of the same material.

The resulting carbon architectures formed in accordance with embodiments of the invention are unique in that they include high-aspect ratio fibers formed of graphite, rather than traditional round or flake-shaped graphite.

Using electrospinning to produce disordered, highly crystalline carbon nanofibers (CNFs) from recycled PET, it is possible to produce stable, low-cost batteries and supercapacitors that are made in a cheap and scalable fashion, which is highly desirable for industrial production.

The materials produced in accordance with embodiments of the invention are used as either graphitized, partially graphitized, or amorphous carbon structures that can produce energy and power performance either on par with incumbent anode materials or greater. The final material (after the process described above) exists as a carbonized mat or fabric, between 2s0 μm-2 mm thick, composed of interwoven or nonwoven micro or nanofibers, with very high carbon purity (90-100% carbon by weight), with a range of crystallinity or graphitization.

This material is able to have long-range graphitization, which is analogous to a graphite particle (usually spherical or flake-like) with a high-aspect ratio, carbon fiber-like architecture. An exemplary range of “high-aspect” ratio is between 2:1 and 10000:1 (fiber length to diameter).

The material may also be hierarchically porous depending on pre-carbonization treatment, e.g., may include micropores having a diameter of <2 nm, mesopores having a diameter selected from a range of 2 to 50 nm, and macropores having a diameter of >50 nm. A volume of the micropores may be selected from a range of 1 to 20%, a volume of the mesopores may be selected from a range of 1 to 20%, and a volume of the macropores may be selected from a range of 2 to 30%. The material may be embedded with active material particles, including at least one of microparticles, nanoparticles, nanorods, nanofibers, or nanowires including silicon, germanium, any carbon allotrope, sulfur, selenium, nitrogen, oxygen, phosphorus, a metal (e.g., tin, aluminum, nickel, or copper), a metal oxide, a metal phosphate, a metal sulfide, and/or combinations thereof, to increase energy density of the device into which it is be incorporated.

For the carbonization/pyrolysis step, alternative methods of carbonizing may enhance the material's ability to retain its morphology post-pyrolysis. For example, some furnaces and heaters can reach high temperatures very quickly, e.g., in a matter of a few seconds. Infrared (IR) and plasma heaters are examples, as well as various laser-based heaters which can heat up very rapidly. Using such heaters may prevent local melting of the plastic materials and fibers during introduction of pyrolytic temperatures. This can be done through virtue of the glass transition properties of a given material, and the time constant at which a material starts to melt. Using these types of heating apparatuses, overcoming glass transitions of plastics may be achieved, and the original morphology (fiber, for example) may be retained while the material converts into carbon.

In the plastic feedstock itself (pre-pyrolysis), additional additives may be included to enhance the properties of the resulting pyrolytic carbonized plastic product. For example, silicon particles can be loaded into the solution before electrospinning (or at any point before carbonization), such as after carbonization. The fibers may “house” the additive particles. Silicon is a good example since it is a common additive in Li-ion battery anodes in low ratios; the process herein may prove to yield superior battery performance over traditional mixing methods in industry, due to the incorporation of additive particles in the resulting carbonized plastic fibers structures. This eliminates wetting problems for slurry making, improves electronic conductivity, improved homogeneity of particle dispersion/distribution throughout the electrode, etc. Other additive particles can be at least one of microparticles, nanoparticles, nanorods, nanofibers, or nanowires, which may include at least one of silicon, germanium, a carbon allotrope, sulfur, selenium, nitrogen, oxygen, phosphorus, a metal (e.g., tin, aluminum, nickel, or copper), a metal oxide, a metal phosphate, a metal sulfide, and/or combinations thereof, and any other electrochemically active composite particle, whether insulating, semiconducting, or conducting. As used herein, “electrochemically active” means being capable of undergoing a chemical reaction within a particular voltage range (relating to electrochemical potential); for Li-ion batteries being between 0 and 6V.

The following steps outline the process of converting waste plastics into high performance carbonaceous electrode material with fibrous morphology, and may be used in multiple applications throughout industry; the addition of particles may enhance the performance of the resulting material in batteries. Accordingly, the following steps are a summary of the process above, and provide an exemplary process for forming carbonized fibers from plastic, optionally with incorporated additives:
1. Referring again to FIG. 5 and FIG. 6, a plastic such as polyethylene terephthalate (PET) is obtained from recycled bottles by collecting bottles and melting them at near 250° C. or dissolving the bottles in a solvent such as trifluoroacetic acid (TFA) or a different suitable complimentary solvent (e.g., acids, organics, etc.).
2. Other active material additives may be loaded into the slurry or melt to improve energy density or power density of the resulting material. These materials may include at least one of microparticles, nanoparticles, nanorods, nanofibers, or nanowires, which may include at least one of silicon, germanium, a carbon allotrope, sulfur, selenium, nitrogen, oxygen, phosphorus, a metal (e.g., tin, aluminum, nickel, or copper), a metal oxide, a metal phosphate, a metal sulfide, and/or combinations thereof. These ultimately become embedded into the interwoven or nonwoven carbon architecture. The metals or metal oxides may include at least one of tin, lead, a semimetal, a transition metal, an alkaline earth metal, or an alkali metal.
3. Referring to FIGS. 5 and 6, the PET melt or solution is loaded into a syringe (volume of 10-500 mL), which is mounted on a syringe pump (e.g., a New Era NE-300 “Just Infusion” Syringe Pump).
4. The flow rate is controlled and the melt or solution is pumped out to a conductive tip (flow rate=1 μL/min-1 mL/min, conductive tip material=metallic, brass alloy, steel alloy, aluminum alloy, carbon-coated metals and alloys, etc.). The conductive tip may be a standard syringe needle tip, or a specifically designed conductive tip, such as one supplied by an electrospinner company (Spraybase, for example).
5. A power source is connected to the conductive tip and a collecting substrate (substrate is ideally conductive (steel, aluminum, copper, etc.), but may also be ceramic or another semiconductive material (for example: silicon or germanium, or a composite of such materials)s and may also be coated with organic polymeric materials (e.g., poly (methyl methacrylate), polylactic acid, polyvinyl carbonate, polyimide, polypropylene, polyethylene, etc.).
6. A DC voltage, of e.g., between 5 kV and 50 kV, is applied to the conductive tip.
7. A Taylor cone is formed at the tip, from which polymer fibers are extruded and collected on the collection substrate (the working distance between the tip and the substrate may be between 50 μm-30 cm). A collection substrate may be a current collector, and the surface on which the fibers are collected, and is preferably made of a conductor or a semiconductor.
8. The collected fibers are then carbonized via heat ramping inside a tube furnace (e.g., OTF-1200X-type, manufactured by MTI), spot furnace, laser or IR furnace, during which a heat source rapidly ramps heat to between 300° C. and 1200° C. within minutes.
9. The resulting carbonized fibers are utilized directly as an electrode in a battery or supercapacitor. That is to say, the fibers themselves act as both the supporting structure of the electrode, as well as the active material. Alternatively, the carbonized fibers may be ground and mixed into a slurry and slurry-casted via the traditional method of electrode fabrication using solvents (such as water, alcohol, glycols, n-methyl pyrrolidone, etc.), conductive additive (e.g., carbon black, graphite, SuperP, ketjen black, etc.), and a binder (e.g., polyvinylidene fluoride, carboxymethyl cellulose-styrene butadiene rubber, alginate, polyacrylic acid, etc.).
10. The carbonized fiber fabric may be used directly as a freestanding negative electrode in an energy storage device, instead of the need for slurry-casting fabrication such as in Step 9.
11. The electrodes described above are incorporated into a battery or supercapacitor. In a battery, the electrode described above acts as the negative electrode, which is welded to a current collector (made of, e.g., copper or nickel), and is added as a layer in a stack of alternating layers of negative electrode, separator (composed of polypropylene, polyethylene, a ceramic material such as alumina, or a combination of these, with or without chemical functionalization), and positive electrode (which is welded to a current collector (made of, e.g., aluminum)). The number of layers may vary, and the form factor of the battery may vary. The entire device interior may be flooded with liquid electrolyte or a solid electrolyte may be used. For a supercapacitor, the electrode described above is included as both the negative and positive electrode, with the same architecture described for the battery, and a KOH electrolyte is used. For a lithium-ion battery, the positive and negative electrode materials differ, the current collector for the anode may be copper or nickel, the current collector for the cathode may be aluminum, and the electrolyte salt used may be lithium hexafluorophosphate (LiPF₆) dissolved in various organic carbonate solvents (e.g., dimethyl carbonate, diethyl carbonate, ethylene carbonate, vinylene carbonate, fluoroethylene carbonate, ethyl methyl carbonate, etc.), or a solid electrolyte may be used. The electrode dimensions vary depending on the battery or supercapacitor form factor (i.e., coin cell, pouch cell or cylindrical cell, or other). The positive electrode includes active battery materials such as metal oxides, and sulfur or oxygen-based materials.

The electrode materials produced from the materials and processes described herein can be utilized in both the negative and positive sides of secondary batteries, and are also applicable to electrodes in primary batteries. For secondary (rechargeable) batteries, the carbon itself can serve as a high capacity anode (negative electrode) in Li-ion and other battery chemistries. It can also serve as the conductive scaffolding for cathode (positive electrode) active materials on the cathode side of Li-ion batteries; for example, the resulting carbon fibers can be impregnated with metal oxides, metal oxide composites, sulfur, or other electroactive conversion materials either in-situ or post-fabrication. These types of architectures and materials resulting from recycled bottles and using electrospinning improve energy density and cycle life several fold through control of the micro- and nanostructures of these energy storage electrodes. To improve the performance of the carbon material, and to encourage the electrospun plastics to retain their structure and morphology after pyrolysis, a polypyrrole (Ppy) coating may be added before pyrolysis, which is described below (forming carbonized Ppy-coated plastic fibers).

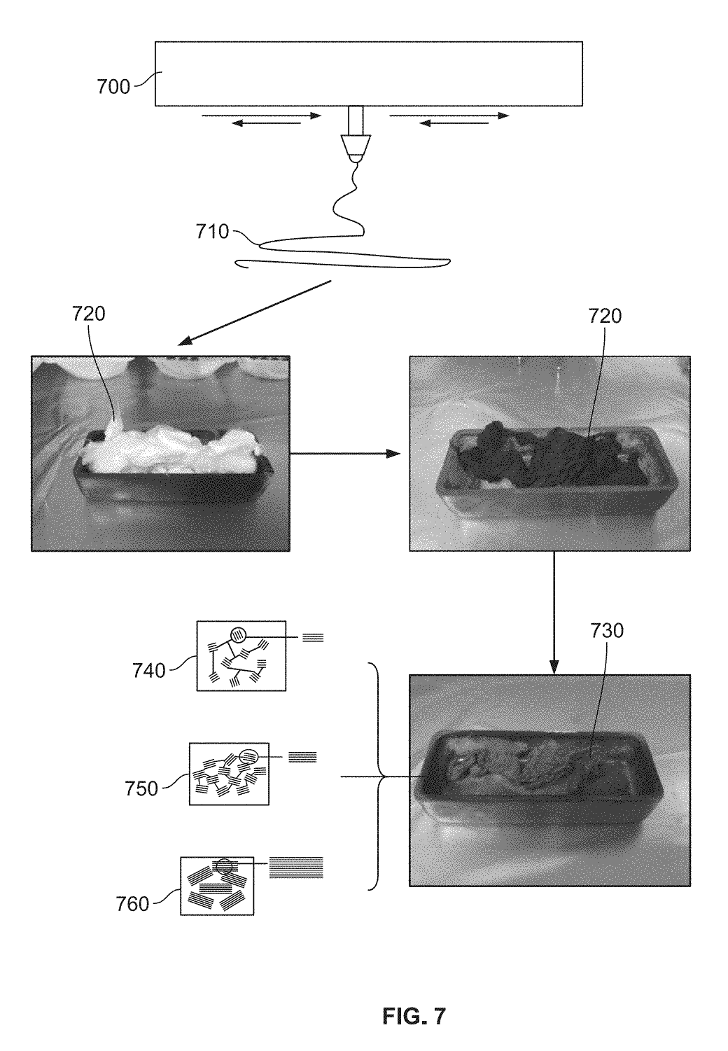

The schematic in FIG. 7 illustrates how the waste plastic may be electrospun into fibers and then pyrolyzed into carbonaceous fibers, in accordance with embodiments of the invention. This involves using an electrospinner 700 to form a woven or nonwoven plastic fabric 710 on the collection substrate. This fabric 720 is collected from the collection substrate prepared for further processing. The plastic fibers may undergo Ppy-coating prior to carbonization, forming Ppy-coated plastic fibers 730; this changes the color of the fibers from white to black. A subsequent step is to carbonize the plastic fibers, whether previously Ppy-coated or not, forming carbonized plastic fibers 740. As shown in FIG. 7, the final carbonized plastic product may have varying crystallinity and microstructure; either lower graphitization 750 (smaller crystallite size, very random crystallite orientation), mild graphitization 760 (larger crystallite size, some random crystallite orientation), and high graphitization 770 (large crystallite size, low crystallite disorder). It then shows how the fibers may have varying crystallinity, and then are incorporated into Li-ion cells or other batteries (either as anode active material, conductive material, or another component).

### Ppy-Coated Fibers

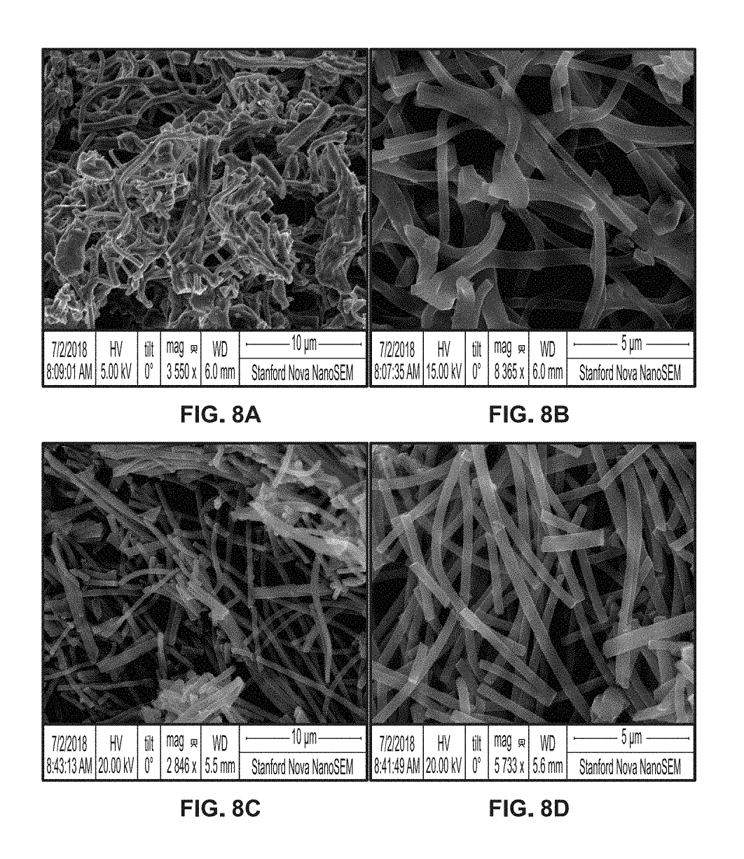

The plastic fibers can be coated with polypyrrole (Ppy), a polymer containing repeating units of the pyrrole monomer. The morphology of the fibers themselves can range from 20 nm to 20 μm. Typical fiber morphology can be seen in FIGS. 8a-8d, which shows SEM characterization of carbonized Ppy-coated electrospun PET fibers (FIGS. 8a-b), as well carbonized Ppy-coated electrospun polyacrylonitrile (PAN) fibers (FIGS. 8c-d). It can thus be seen that multiple plastics and polymers can be used in this same process, and Ppy-coating the electrospun fabrics encourages the retention of the fibers' morphology after carbonization (pyrolysis). This may be done using a physical vapor deposition (sometimes called chemical vapor deposition) method. The process involves the following: After the electrospun plastic fibers are obtained, they are impregnated with iron (III) chloride (FeCl₃) via a solution of FeCl₃ in isopropanol, water, or other suitable solvent. The solvent is then evaporated ambiently, or under vacuum, or under heat (up to 100° C.) or a combination of these methods, until the material is dry. Next, the FeCl₃-impregnated fibers are exposed to pyrrole vapors; this may be done in a chamber under vacuum, or under ambient pressure. The temperature range for this step does not need to be high, but may be in the range of 0-60° C. The fibers are then exposed to the vapors for 15 mins-36 hours; the time needed depends on the thickness of the fibers, the concentration of the FeCl₃ solution used, and the surface concentration of FeCl₃ on the fibers (and environmental temperature). After the coating, the fibers turn from whitish or off-white to black, as FeCl₃ catalyzes the polymerization of Ppy on the surface of the fibers. Ultimately, this forms a conformal coating of Ppy on the plastic fibers. Next, the FeCl₃ is removed, which may be achieved by simple washing with water, isopropanol, or another suitable solvent that can dissolve and wash away the FeCl₃. Acids may also be used in this step to remove any iron from the material. The material is then dried, ambiently or under vacuum, with or without heat. The material is then ready for carbonization (pyrolysis), and the resulting carbon product is one of the products/concepts as a basis for the embodiment of this invention.

The below process flow differs from previously described processes as it details the process of coating the plastic fibers with Ppy prior to pyrolysis. A method of forming an electrode in accordance with embodiments of the invention may include the following steps.

First, recycled PET plastic is recovered or collected and washed with DI H₂O, then dried statically or under vacuum. Alternatively, another plastic is sourced and obtained. The plastic samples are pulverized and broken down using blenders or high-power shredders, after which they are dissolved in an appropriate solvent for an electrospinning solution (e.g., 0.05-500 mg/mL concentration), or melted at or near 250° C.

At this step, particle additives may also be mixed in with the solution or melt.

Next, the solution or melt is loaded into a syringe, which is mounted onto a syringe pump. The syringe is connected to a conductive tip, or is connected to a plastic or metal tubing with a conductive tip on the end. Leads of a power supply (ex: WYS-30-1 type high-voltage power supply) are connected to both the conductive tip, and a collection substrate (separate from the pumping system and syringe). A flow rate is then set on the pump (e.g., 1 μL/min-1 mL/min), and the pump is activated, pushing the PET melt or solution toward the conductive tip. A Taylor cone is formed at the tip, at which point the power supply is activated (1 kV-50 kV), and PET fibers are extruded from the melt or solution and collected on the substrate as a woven fabric over time. For polymers other than PET, alternative solvents may need to be used for effective electrospinning solutions to be made. Alternative solvents include other acids that can dissolve thermoplastics, as well as any organic solvent that can dissolve any thermoplastic; while trifluoroacetic acid is primarily used here, other fluorinated organic acids may also be effective. Other effective solvents may include dichloromethane (DCM), toluene, benzene, xylene, combinations of polyaromatic hydrocarbons, chloroform, etc.

Parameters for the heat-treatment phase for the Ppy-coated plastic fibers are then selected. Here, the procedure for carbonization of the fabric is established in terms of fiber diameter, crystallinity, porosity, additive composition and concentration, and overall fabric thickness. During carbonization, the conditions of the furnace need to be anoxic (oxygen replaced with inert gas, such as N₂, Ar, or He). For effective pyrolysis of the Ppy-coated PET fibers containing particulate additives, such as metal oxide particles, silicon particles, silicon oxide particles, tin particles, etc., the electrospun fibers may be stabilized through a lower-temperature heat-treatment (between 250-500° C.), to enhance the mechanical and electronic properties of the resulting carbon fibers before a high temperature heat treatment. However, a preferred pyrolysis of the fibers (with or without particle additives) is carried out very rapidly, bringing the sample temperature from room temperature to a temperature selected from the range of 300-3500° C. within 3 seconds-5 minutes this is to avoid local melting due to the glass transition temperature of PET material (the temperature is held for between 3 minutes and 3 hours). Using fast ramp rate, as such, allows the temperature to surpass the glass transition temperature of the PET without allowing it to melt (T_{g} for PET is between 67-81° C., depending on crystallinity). Although this fast-ramping may not be necessary to achieve pyrolytic carbon product, it may be ideal to heat the material in such a way. To further graphitize the material, the temperature may need to be ramped between 1500-3500° C. Rapid heating furnaces or heaters can be used, such as IR, laser, or plasma heaters, to reach these high temperatures in a matter of seconds; this may help the plastic fibers retain their structure/morphology post-carbonization by overcoming the glass transition temperature in a short amount of time.

To promote pore formation and further increase surface area, the carbon fabric may be first subjected to a KOH-activation. This process involves submerging the fabric in a KOH solution (0.1-6M) for between 30 minutes-12 hours to soak. After the fabric containing KOH solution fully dries (under vacuum or statically), the fabric is placed back into a furnace and heated to 300-1400° C. for between 3 minutes and 3 hours. After the final product is washed with DI H₂O and alcohol, and dried, it is incorporated in the supercapacitor or battery as an electrode. A supercapacitor is assembled in generally the same fashion as a battery, except both electrodes are made of the same material.

The resulting carbon architectures formed in accordance with embodiments of the invention includes high-aspect ratio fibers formed of graphite or graphitic carbon, rather than traditional round or flake-shaped graphite. The fibers may also include an outer layer of carbon with different crystallinity, purity, porosity, and/or structure than that of what comprises the “core” of the fibers (this is due to the previous Ppy-coating). The Ppy-coating, described above, enables the final material to retain its morphology and structure, and also provides a stabilizing carbon layer on the surface of the core carbonized plastic material, enhancing the cycle stability of the carbon anodes made from the material in Li-ion batteries. Ppy is the polymer or the monomer units, pyrrole, linked together in long chains. This is formed during the physical vapor deposition (or chemical vapor deposition) step in the synthesis. This is also known to be a conductive polymer (although it is converted to carbon during pyrolysis). During pyrolysis, the Ppy at elevated temperatures may form a compound with the plastic material on the core of the coated fibers, resulting in a unique structure of carbon after pyrolysis. SEM characterization shows a core-shell structure to the carbonized PPy-coated PET fibers, with many of the fibers being partially hollow. The shell component of the fibers is mainly composed of carbonized PPy, while the core is composed of mainly carbonized PET, or other plastic material (whichever plastic was used in the synthesis).

Using electrospinning to produce disordered, highly crystalline CNFs from recycled PET, it is possible to produce stable, low-cost batteries and supercapacitors that are made in a cheap and scalable fashion, which is highly desirable for industrial production.

The materials produced in accordance with embodiments of the invention are used as either graphitized, partially graphitized, or amorphous carbon structures that can produce energy and power performance either on par with incumbent anode materials or greater. The final material (after the process described above) exists as a carbonized mat or fabric, between 20 μm-2 mm thick, composed of interwoven or nonwoven micro or nanofibers, with very high carbon purity (90-100% carbon by weight), with a range of crystallinity or graphitization.

This material has the ability to have long-range graphitization, which is analogous to a graphite particle (usually spherical or flake-like) with a high-aspect ratio, carbon fiber-like architecture. An exemplary range of “high-aspect” ratio is between 2:1 and 10000:1 (fiber length to diameter).

The material may also be hierarchically porous depending on pre-carbonization treatment, e.g., may include micropores having a diameter of <2 nm, mesopores having a diameter selected from a range of 2 to 50 nm, and macropores having a diameter of >50 nm. a volume of the micropores may be selected from a range of 1 to 20%, a volume of the mesopores may be selected from a range of 1 to 20%, and a volume of the macropores may be selected from a range of 2 to 30%.

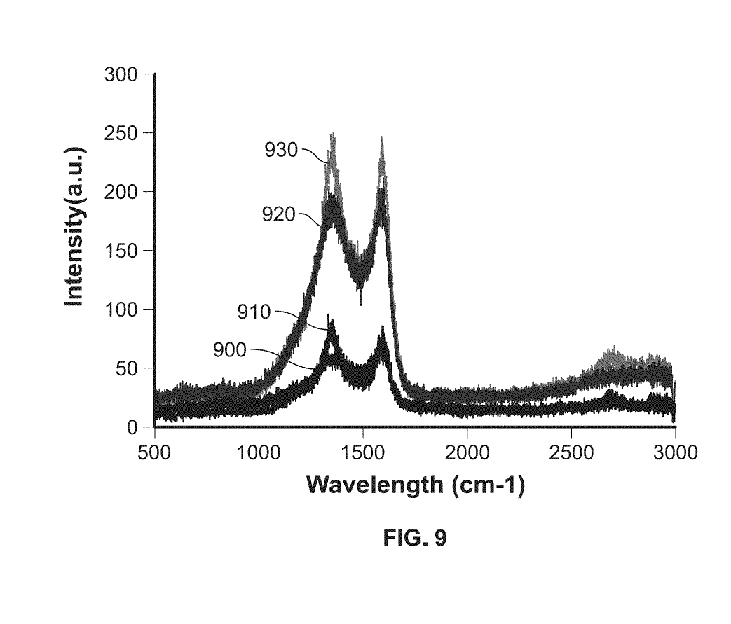

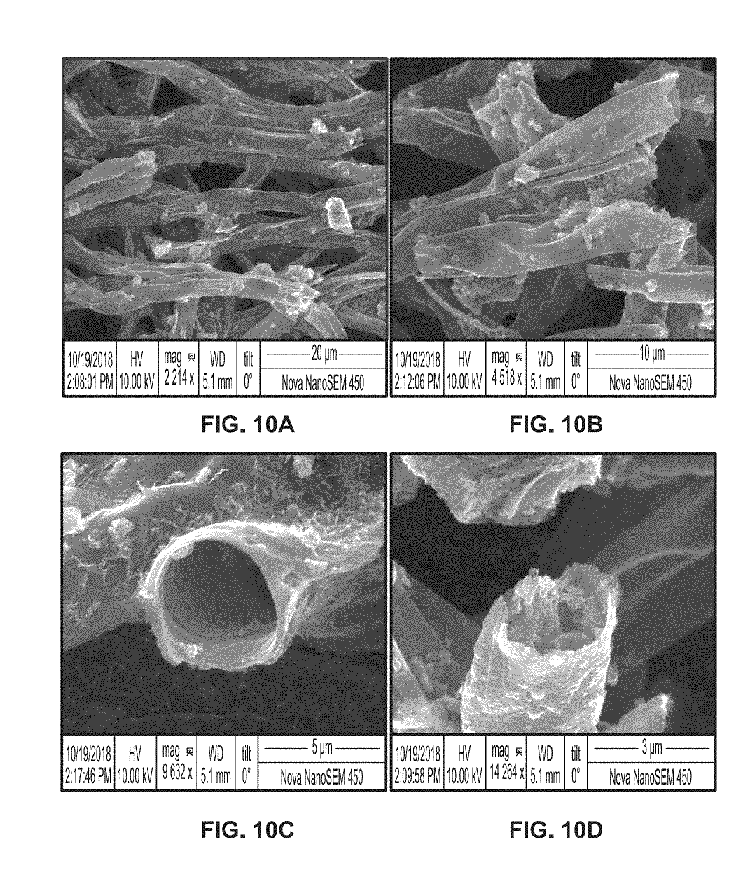

Referring to FIG. 9, Raman spectroscopy was used to characterize the Ppy-coated fibers after heat treatment at both 800° C. 900, 910, and 1000° C. 920, 930. The distinction between peak intensities can be noticed as the temperature of pyrolysis is increased; as well, the broader peaks above 2500 cm⁻¹ begin to manifest, indicating the beginnings of graphitization of the carbon (moving toward “turbostratic” crystallite arrangement). The material may be embedded with active material particles including at least one of microparticles, nanoparticles, nanorods, nanofibers, or nanowires, which may include at least one of silicon, germanium, a carbon allotrope, sulfur, selenium, nitrogen, oxygen, phosphorus, a metal, a metal oxide, a metal phosphate, a metal sulfide, and/or combinations thereof, to increase the energy density of the device into which it is be incorporated. For example, FIG. 10 shows SEM characterization of the Ppy-coated PET fibers, with silicon particles having been loaded into the PET fabric before Ppy-coating and subsequent carbonization; FIG. 10a-b show lower magnification images of the fibers, while FIG. 10c-d show higher magnification of the fibers near their ends, showing that the fibers are partially hollow, and the silicon particles are visible on the inner surface of the fibers. A large proportion of the total silicon particles loaded into the fibers are thought to be incorporated into the carbon walls of the fibers.

This process below differs from the previously described processes in that the resulting electrospun fibers are coated with polypyrrole (Ppy) prior to carbonization (pyrolysis), creating unique carbon structures that are distinct from the structures previously mentioned. The process below is a summary of the process for the preparation of Ppy-coated plastic fibers, as well as their carbonization, which ultimately leads to a structure comprising a core-shell architecture after pyrolysis. These may also be used in multiple industrial applications, and may also comprise particulate additives. The summary of the above process is as follows:
1. Referring again to FIG. 6, a plastic such as polyethylene terephthalate (PET) is obtained from recycled bottles by collecting bottles and melting them at near 250° C. or dissolving the bottles in a solvent such as trifluoroacetic acid (TFA) or a different suitable complimentary solvent (e.g., acids, organics, etc.).
2. Other active material additives may be loaded into the slurry or melt to improve energy density or power density of the resulting material. These materials may include eat least one of microparticles, nanoparticles, nanorods, nanofibers, or nanowires, which may include at least one of silicon, germanium, a carbon allotrope, sulfur, selenium, nitrogen, oxygen, phosphorus, a metal (e.g., tin, aluminum, nickel, or copper), a metal oxide, a metal phosphate, a metal sulfide, and/or combinations thereof. The metals or metals oxides may comprise of at least one of tin, lead, a semimetal, a transition metal, an alkaline earth metal, or an alkali metals. These ultimately become embedded into the interwoven or nonwoven carbon architecture. The loading of these added particles can be between 0.01-70 wt. % of the total composite material, either before or after pyrolysis. The resulting composites from this process may be used in either the positive or negative electrode as active material.
3. Referring to FIGS. 6 and 7, the PET melt or solution is loaded into a syringe (volume of 10-500 mL), which is mounted on a syringe pump (e.g., a New Era NE-300 “Just Infusion” Syringe Pump). Alternatively, another plastic with an appropriate solvent may be used to form an electrospinning solution.
4. The flow rate is controlled and the melt or solution is pumped out to a conductive tip (flow rate=1 μL/min-1 mL/min, conductive tip material=metallic, brass alloy, steel alloy, aluminum alloy, carbon-coated metals and alloys, etc.). The conductive tip may be a standard syringe needle tip, or a specifically designed conductive tip, such as one supplied by an electrospinner company (Spraybase, for example).
5. A power source is connected to the conductive tip and a collecting substrate (substrate is ideally conductive (steel, aluminum, copper, etc.), but may also be ceramic or another semiconductive material (for example: silicon or germanium, or a composite of such materials)s and may also be coated with organic polymeric materials (e.g., poly (methyl methacrylate), polylactic acid, polyvinyl carbonate, polyimide, polypropylene, polyethylene, etc.).
6. A DC voltage, of e.g., between 5 kV and 50 kV, is applied to the conductive tip.
7. A Taylor cone is formed at the tip, from which polymer fibers are extruded and collected on the collection substrate (the working distance between the tip and the substrate may be between 50 μm-30 cm). A collecting substrate is also a current collector, and the surface on which the fibers are collected.
8. The fibers are then collected and impregnated with FeCl3; this is done by immersing the fabric into an FeCl₃ solution of varying concentration (0.01-3M FeCl₃) in water, isopropanol, or other appropriate solvent that does not also dissolve the plastic. The fibers soak in the solution for 10 minutes-24 hours, or as long as it takes to fully wet the fabric. The fabric is then dried under ambient conditions, or under heat and vacuum, or just vacuum, until the fibers are completely dry.
9. After the fibers are impregnated with FeCl₃, the fibers are then exposed to pyrrole vapors in a chamber in ambient pressure, or under vacuum. In this closed chamber (or open to vacuum), the pyrrole vapors come out of the vapor phase, and nucleate at the FeCl₃ impregnation sites on the plastic fibers, where the synthesis of Ppy is catalyzed. After between 10 minutes and 36 hours, the entirety of the plastic fibers are coated in a black layer of Ppy. The pyrrole may be housed in a vial or other introduction method, as long as the liquid pyrrole can supply enough vapors to completely coat the plastic fibers in Ppy.
10. The FeCl₃ residing in the material is removed through thorough washing with water, ispropanol or an alternative appropriate solvent than can easily remove iron and chlorides. Dilute acid solutions may also effectively remove the FeCl₃ from the structure. Washing continues until no FeCl₃ is detectable. The fibers are then dried under ambient conditions, under vacuum, under heat, or a combination of these methods.
11. The collected fibers are then carbonized via heat ramping inside a tube furnace (e.g., OTF-1200X-type, manufactured by MTI), spot furnace, laser or IR furnace, during which a heat source rapidly ramps heat to between 300° C. and 3500° C. within minutes (ideally; a slower ramp may be used, and temperatures up to 3500° C. may be used to increase graphitization).
12. The resulting carbonized fibers are utilized directly as an electrode in a battery or supercapacitor. The fibers themselves act as both the supporting structure of the electrode, as well as the active material. Alternatively, the carbonized fibers may be ground and mixed into a slurry and slurry-casted via the traditional method of electrode fabrication using solvents (such as water, alcohol, glycols, n-methyl pyrrolidone, etc.), conductive additive (e.g., carbon black, graphite, SuperP, ketjen black, etc.), and a binder (e.g., polyvinylidene fluoride, carboxymethyl cellulose-styrene butadiene rubber, alginate, polyacrylic acid, etc.).
13. The carbonized fiber fabric may be used directly as a freestanding negative electrode in an energy storage device, rather than using the slurry-casting method as described in step 12.
14. The electrodes described above are incorporated into a battery or supercapacitor; in a battery, the electrode described above acts as the negative electrode, which is welded to a current collector (made of, e.g., copper or nickel), and is added as a layer in a stack of alternating layers of negative electrode, separator (composed of polypropylene, polyethylene, a ceramic material such as alumina, or a combination of these, with or without chemical functionalization), and positive electrode (which is welded to a current collector (made of, e.g., aluminum)). The number of layers may vary, and the form factor of the battery may vary. The entire device interior may be flooded with liquid electrolyte or a solid electrolyte may be used. For a supercapacitor, the electrode described above is included as both the negative and positive electrode, with the same architecture described for the battery, and a KOH electrolyte is used. For a lithium-ion battery, the positive and negative electrode materials differ, the current collector for the anode being copper or nickel, the current collector for the cathode being aluminum, and the electrolyte salt used being LiPF₆ (lithium hexafluorophosphate) dissolved in various organic carbonate solvents (e.g. dimethyl carbonate, diethyl carbonate, ethylene carbonate, vinylene carbonate, fluoroethylene carbonate, ethyl methyl carbonate, etc.), or a solid electrolyte may be used. The electrode dimensions vary depending on the battery or supercapacitor form factor (i.e., coin cell, pouch cell or cylindrical cell, or other). The positive electrode includes active battery materials such as metal oxides, and sulfur or oxygen-based materials.

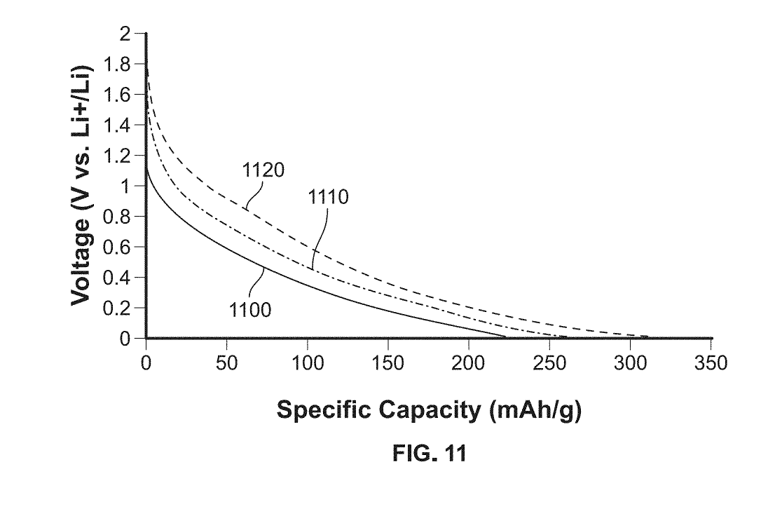

The above process differs from other coating methods in that it does not involve plasma, wet coating, milling, or high-temperature processes. This Ppy-coating occurs at room temperature and ambient pressure. FIG. 11 shows electrochemical data from half-cell coin cells (lithium counter electrode vs. various fabricated carbon working electrodes), compiled from samples including: carbonized plastic after pyrolysis at 800° C. 1100, carbonized plastic after pyrolysis at 1000° C. 1110, and carbonized Ppy-coated PET fibers heat treated at 1000° C. 1120. The data represents the discharge curves for each sample in the half cell using typical Li-ion electrolyte (1:1 ethylene carbonate/dimethyl carbonate, 1M LiPF₆). The current density used for cycling each sample cell was approximately C/5, with respect to each sample's dynamic measured capacity. The loading of the fabricated carbon electrodes ranged from ˜1 mg-15 mg per cm² on copper current collectors. The trends in performance can be noticed by looking at the specific capacity (mAh/g) corresponding to the end of each discharge; the highest performing sample is the carbonized Ppy-coated plastic fibers at nearly 320 mAh/g; updated data shows performance of up to 375 mAh/g. This can be attributed to improved wetting, accommodated volume expansion by embedded silicon particles into the fibers, and increased conductivity, as well as the core-shell structure of the material. The performance of the carbonized plastic samples is expected to increase dramatically after increasing the pyrolysis temperature higher than 1000° C., upwards of 3000° C. In addition, the performance of the material may also improve after acidifying and/or dissolving the PET or other plastic precursors in various acids or solvents, and re-precipitating the polymers before carbonization.

The described embodiments of the invention are intended to be merely exemplary and numerous variations and modifications will be apparent to those skilled in the art. All such variations and modifications are intended to be within the scope of the present invention as defined in the appended claims.

What is claimed is:

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. A method for fabricating a battery or a supercapacitor, the method comprising the steps of:
collecting plastic;
rinsing the plastic with a liquid to remove residues;
performing a high-temperature carbonization of the plastic to form carbonized plastic; and
fabricating a carbonaceous electrode from the carbonized plastic.

26. (canceled)

27. The method of claim 25, wherein the plastic comprises at least one of polyethylene terephthalate, polyamides, polycarbonates, polyesters, polyethylenes, polypropylenes, polystyrenes, polyurethanes, polyvinyl chlorides, polyvinylidene chlorides, acrylonitrile butadiene styrenes, polyepoxide trifluorides, polymethyl methacrylates, polytetrafluoroethylenes, phenolics, melamine formaldehydes, urea-formaldehydes, polyetheretherketones, maleimides, polyetherimides, polyimides, plastarches, polylactic acids, furans, silicones, or combinations thereof.

28. (canceled)

29. (canceled)

30. (canceled)

31. The method of claim 25, wherein fabricating the carbonaceous electrode comprises adding the carbonized plastic to a slurry and slurry-casting.

32. The method of claim 25, further comprising incorporating the carbonaceous electrode into a battery housing or a supercapacitor housing.

33. (canceled)

34. (canceled)

35. The method of claim 25, wherein the high-temperature carbonization of the plastic comprises heating the plastic to a temperature selected from a range of 450° C. to 3500° C. under inert gas.

36. (canceled)

37. The method of claim 25, wherein the collected plastic after the rinsing step and prior to low-temperature heat treatment is at least one of dissolved or acidified and subsequently re-precipitated.

38. The method of claim 25, wherein a polymeric property of the collected plastic is different after dissolution or acidification, the polymeric property including at least one of shortened chain length, lengthened chain length, crosslinking, chain cleavage, crystallinity, functionalization, or combinations thereof.

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. A method for fabricating an energy storage device, the method comprising the steps of:
liquefying recycled bottles comprising a plastic by at least one of melting the plastic and dissolving the plastic in a solvent;
delivering the liquefied plastic to a conductive tip;
applying a high voltage to the conductive tip to extrude plastic fibers therefrom;
collecting the extruded plastic fibers on a collection substrate;
pyrolyzing the plastic fibers; and
forming an electrode for the energy storage device from the pyrolyzed plastic fibers.

54. The method of claim 53, wherein the plastic comprises at least one of polyethylene terephthalate, polyamides, polycarbonates, polyesters, polyethylenes, polypropylenes, polystyrenes, polyurethanes, polyvinyl chlorides, polyvinylidene chlorides, acrylonitrile butadiene styrenes, polyepoxide trifluorides, polymethyl methacrylates, polytetrafluoroethylenes, phenolics, melamine formaldehydes, urea-formaldehydes, polyetheretherketones, maleimides, polyetherimides, polyimides, plastarches, polylactic acids, furans, silicones, or combinations thereof.

55. (canceled)

56. The method of claim 53, wherein the plastic is liquefied by dissolving in the solvent, and the solvent is triflouroacetic acid.

57. (canceled)

58. (canceled)

59. The method of claim 53, wherein the electrode is a carbonaceous anode.

60. (canceled)

61. The method of claim 53, wherein the energy storage device is selected from the group consisting of a battery and a supercapacitor.

62. The method in claim 53, wherein the plastic fibers are pyrolyzed at a temperature selected from a range of 500 to 3500° C. under inert gas.

63. (canceled)

64. (canceled)

65. (canceled)

66. (canceled)

67. (canceled)

68. (canceled)

69. (canceled)

70. (canceled)

71. (canceled)

72. (canceled)

73. (canceled)

74. (canceled)

75. (canceled)

76. (canceled)

77. (canceled)

78. (canceled)

79. (canceled)

80. (canceled)

81. A method for fabricating an energy storage device material, the method comprising the steps of:
liquefying a plastic by at least one of melting the plastic or dissolving the plastic in a solvent;
delivering the liquefied plastic to a conductive tip;
applying a high voltage to the conductive tip to extrude plastic fibers therefrom;
collecting the extruded plastic fibers on a collection substrate;
impregnating the plastic fibers with FeCl₃ by (i) immersion in FeCl₃ solution, and (ii) drying of the plastic fibers;
coating the FeCl₃-impregnated plastic fibers with polypyrrole by exposure to pyrrole vapors;
removing at least one of excess FeCl₃ or iron from the polypyrrole-coated plastic fibers;
pyrolyzing the polypyrrole-coated plastic fibers; and
forming an electrode for the energy storage device from the pyrolyzed plastic fibers.

82. The method of claim 81, wherein the plastic comprises at least one of polyethylene terephthalate, polyamides, polycarbonates, polyesters, polyethylenes, polypropylenes, polystyrenes, polyurethanes, polyvinyl chlorides, polyvinylidene chlorides, acrylonitrile butadiene styrenes, polyepoxide trifluorides, polymethyl methacrylates, polytetrafluoroethylenes, phenolics, melamine formaldehydes, urea-formaldehydes, polyetheretherketones, maleimides, polyetherimides, polyimides, plastarches, polylactic acids, furans, silicones, or combinations thereof.

83. (canceled)

84. The method of claim 81, wherein the plastic is liquefied by dissolving in the solvent, and the solvent is triflouroacetic acid.

85. (canceled)

86. (canceled)

87. The method of claim 81, wherein the electrode is a carbonaceous anode.

88. (canceled)

89. (canceled)

90. The method in claim 81, wherein the plastic fibers are pyrolyzed at a temperature selected from a range of 500 to 3500° C. under inert gas.

91. (canceled)

92. (canceled)

93. (canceled)

94. (canceled)

95. (canceled)

96. (canceled)

97. (canceled)

98. The method of claim 81 wherein the FeCl₃ solution comprises a concentration of FeCl₃ of between 0.01 to 6M FeCl₃.

99. (canceled)

100. (canceled)

101. (canceled)

102. (canceled)

103. The method of claim 81, wherein the pyrolyzed fibers comprise dispersed particles comprising at least one of microparticles, nanoparticles, nanorods, nanofibers, or nanowires comprising at least one of silicon, germanium, a carbon allotrope, sulfur, selenium, nitrogen, oxygen, phosphorus, a metal, a metal oxide, a metal phosphate, a metal sulfide, or combinations thereof.
